(19) United States
(12) Patent Application Publication
(10) Pub. No.: US 2005/0068021 A1
(43) Pub. Date: Mar. 31, 2005

(54) Sensor system having a single-wire interface

(76) Inventors: Thomas Mager, Pfullingen (DE); Helmut Binder, Neckarsulm (DE); Jochen Huebl, Schwieberdingen (DE)

Correspondence Address: KENYON & KENYON, ONE BROADWAY, NEW YORK, NY, 10004, US

(21) Appl. No.: 10/675,333

(22) Filed: Sep. 29, 2003

(51) Int. Cl. G01B 7/14

(52) U.S. Cl. 324/207.2; 324/207.25; 340/533

(57) ABSTRACT

A sensor system includes a sensor which is connected to an analyzer, which powers the sensor and analyzes a measuring signal generated by the sensor using an analyzer circuit. To simplify the interconnection of sensor and analyzer and make different ground-side connection variants possible, the analyzer circuit is situated on the power supply side of the sensor.

### FIELD OF THE INVENTION

The present invention relates to a sensor system including a sensor and a processing unit connected thereto.

### BACKGROUND INFORMATION

Such sensor systems are used in the most diverse measuring applications. One sensor system known from the automobile industry for measuring a rotational speed of the wheels of a motor vehicle is shown in FIG. 1.

FIG. 1 shows a sensor system known from the related art having a wheel sensor 1 and an analyzer 2 connected thereto. Wheel sensors 1 are usually Hall sensors which act together with a magnetic transducer (not shown) attached to the wheel.

Wheel sensor 1 is supplied with voltage V by analyzer 2 via a two-wire interface (connecting leads 9, 25), via diodes 10, 11 and a switch 12. Wheel sensor 1 also includes two current sources 4, 5, connected in parallel, current source 5 being switchable by a switch 6. When the transducer (not shown) passes by, current source 5 is switched on; otherwise it remains off. In this way square-wave pulses having a current intensity of 7 mA (low level) and 14 mA (high level), for example, are generated, which are modulated onto the supply current. In addition to the supply current, the measuring signal is thus also transmitted over connecting leads 9, 25.

Actual analysis of the measuring signal takes place by current measurement on negative line 25 (ground-side connecting lead) of sensor 1. For this purpose, analyzer 2 includes an analyzer circuit 3 having a measuring shunt 21 in negative line 25 and a comparator 22.

Comparator 22 of analyzer circuit 3, switch 12, and diode 11 are integrated in an IC 18 (ASIC). IC 18 also has a supply-side positive terminal 13 and a ground-side minus terminal 14.

The output of comparator 22 is connected to a microprocessor 19, which may trigger further devices (not shown), such as wheel brakes, for example.

Furthermore, interference-suppressor capacitors 17, 23 are provided in supply line 9 to comply with the EMC standards.

The sensor system illustrated has the disadvantage that the wiring of sensor 1 and analyzer 2 using a two-wire interface is relatively complex and cost-intensive. In addition, electromagnetic interference suppression of ground-side connecting lead 25 requires additional resources.

Another disadvantage of the known sensor system is that the sensor and the analyzer are only connectable in the predefined two-wire configuration, with no possibility to implement other connection variants in special applications.

### SUMMARY OF THE INVENTION

Therefore, an object of the present invention is to provide a sensor system which is more cost-effective and in which the ground side of the sensor is connectable to the analyzer or to ground in different ways as needed.

An essential idea of the present invention is to perform the analysis of the measuring signal delivered by the sensor on the power supply side of the sensor (in other words, on the side where the supply voltage is fed, i.e., on the side of the positive terminal). For this purpose, an analyzer circuit is provided, which is situated on the power supply side of the sensor and which analyzes the measuring signal generated by the sensor and conducted over a supply line. Locating the analyzer circuit on the power supply side of the sensor makes it possible to configure the ground-side connection of the sensor in different ways as needed.

If the sensor has a metal housing, this may be grounded directly (without additional cable connections) by using a pin to which the sensor housing is attached by a threaded or welded connection in particular.

If the sensor is a vehicle sensor such as, for example, a wheel sensor, the pin may be directly attached to the vehicle body. This embodiment has the particular advantage that no additional connecting cable between sensor and analyzer is required on the ground side, and the corresponding ground-side terminals on the sensor and analyzer are no longer needed. EMC protection of the ground-side connecting leads as implemented in the related art by an EMC capacitor 20 may also be omitted.

According to another embodiment of the present invention, the sensor may also be grounded via a short segment of lead, which is connected to the negative terminal of the sensor. This is advantageous in particular when the sensor housing is not made of metal. Also in this case, a ground-side connecting lead between sensor and analyzer, the ground-side terminal of the analyzer, and the EMC protection capacitor may be omitted.

According to a third embodiment of the present invention, the ground side of the sensor is connected to the analyzer by a line, the ground connection being located in the analyzer. The ground-side terminal of the analyzer is preferably directly grounded. Also in this embodiment, the EMC interference-suppressor capacitor connected to the ground-side connecting lead may be omitted.

According to a fourth embodiment of the present invention, the analyzer includes a switch which is located in the negative terminal of the sensor. The switch is preferably integrated in an IC and is itself grounded. This offers the advantage that, in the event of a short-circuit, the sensor ground may be switched off using the switch.

The analyzer circuit for analyzing the measuring signal preferably includes a measuring shunt connected to the supply line and a comparator connected to the measuring shunt. The measuring shunt and/or the comparator are preferably integrated in an IC (ASIC).

### BRIEF DESCRIPTION OF THE DRAWINGS

FIG. 1 shows a sensor system in which the analysis of the measuring signal takes place in the ground-side connecting lead.

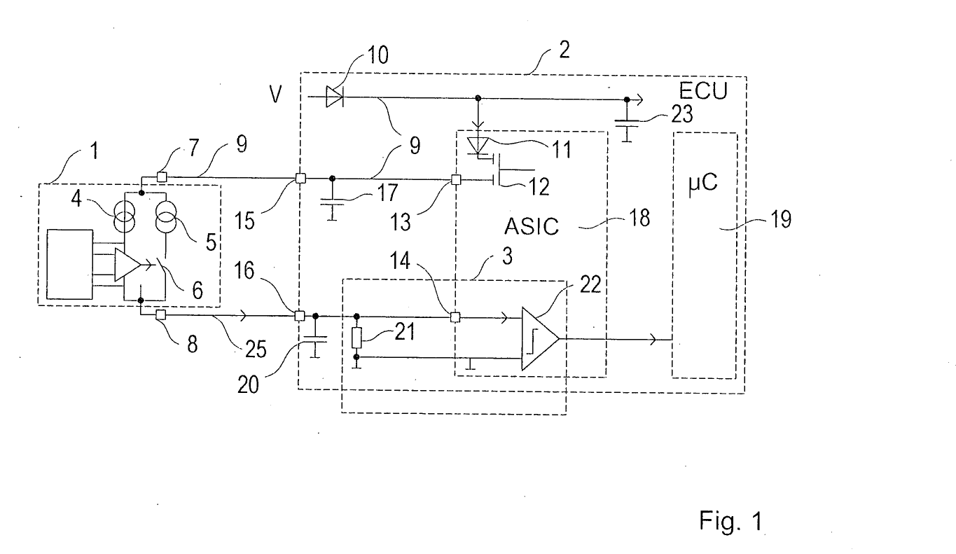

FIG. 2 shows a sensor system according to one embodiment of the present invention with a plurality of connection alternatives.

### DETAILED DESCRIPTION

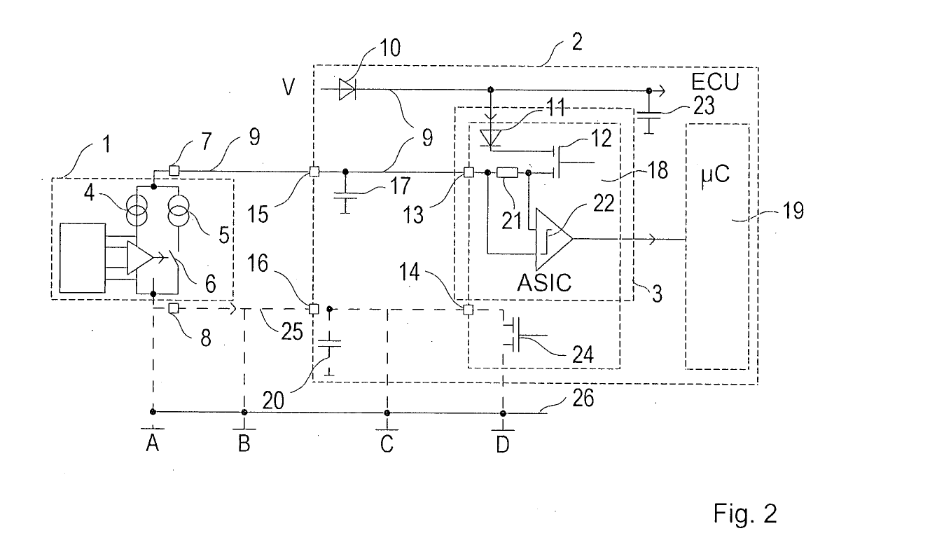

FIG. 2 shows a sensor system having a wheel sensor 1, which is connected to an analyzer 2 via connecting leads 9, 25. Wheel sensor 1 has a positive terminal 7 (supply terminal) to which a supply voltage V is applied, and a ground-side negative terminal 8. Analyzer 12 has corresponding positive and negative terminals 15, 16.

Wheel sensor 1 includes a Hall sensor 27, which generates a signal when a transducer (not shown) attached to a wheel passes by. The signal is used to switch a current source 5 on and off using a switch 6. The sensor signal, i.e., measuring signal, obtained in this way is modulated onto the supply current flowing through supply line 9.

An analyzer circuit 3, which includes a measuring shunt 21 situated in supply line 9 and a comparator 22 connected to the measuring shunt, is provided for analyzing the sensor signal. Measuring shunt 21 and comparator 22 are integrated in an IC (ASIC) 18, which is a component of analyzer 2.

As the figure shows, analyzer circuit 3 is situated on the power supply side of sensor 1. This permits the connection of sensor 1 to ground 26 to be configured as needed. A plurality of connection options of sensor 1 to ground 26 are indicated by reference symbols A through D.

In connection variant A, the sensor housing, if made of metal, is directly connectable to ground 26. Grounding may be implemented using a pin, which is attached to the vehicle housing (body), for example. In this case, negative terminals 8, 16 of sensor 1 and analyzer 2, ground-side connecting lead 25, and EMC interference-suppressor capacitor 20 may be omitted.

In connection variant B, sensor 1 is connected to ground 26 via a short connecting lead 25. This is advantageous, in particular, if the sensor housing is made of plastic, for example, and cannot be directly grounded. In this case at least one segment of ground-side connecting lead 25, negative terminal 16 of analyzer 2, EMC interference-suppressor capacitor 20, and connecting lead, internal to the device, to ASIC 18 may be omitted.

In third connection variant C, negative terminal 8 of sensor 1 is connected to analyzer 2 via ground-side connecting cable 25. Negative terminal 16 of analyzer 2 is directly connected to ground 26. Grounding terminal 26 is within analyzer 2 in this case. Also in this connection variant C, at least the connecting lead, internal to the device, to ASIC 18 and a negative terminal 14 of ASIC 18 may be omitted.

In a fourth connection variant D, negative terminal 8 of sensor 1 is connected to a switch 24, which is integrated in ASIC 18. Switch 24 is normally a transistor, which may be turned off in the case of a short-circuit to interrupt the current flow to ground 26. Switch 24 is triggered by a device (not shown) which is able to detect a short-circuit.

### Reference Symbols

1 sensor
2 analyzer
3 analyzer circuit
4 current source
5 current source
6 switch
7 positive terminal
8 negative terminal
9 supply line
10 diode
11 diode
12 switch
13,14 IC terminals
15,16 terminals of the analyzer
17 EMC capacitor
18 IC
19 microcontroller
20 EMC capacitor
21 measuring shunt
22 comparator
23 capacitor
24 switch
25 ground-side connecting lead
26 ground
A-D connection variants
V supply voltage

1. A sensor system comprising:
a sensor for generating a measuring signal, the sensor having a power supply side; and
an analyzer connected to the sensor, the analyzer powering the sensor, the analyzer including an analyzer circuit, the analyzer circuit being situated on the power supply side of the sensor to analyze the measuring signal generated by the sensor.

2. The sensor system according to claim 1, wherein the sensor includes a metal housing directly connected to ground.

3. The sensor system according to claim 1, wherein the sensor includes a negative terminal connected to ground by a short lead.

4. The sensor system according to claim 1, wherein the sensor includes a negative terminal connected, via a lead, to a ground-side terminal of the analyzer, the ground-side terminal, in turn, being connected to ground.

5. The sensor system according to claim 1, wherein the analyzer includes an IC including a switch connected to ground integrated in it, the switch being connected to a negative terminal of the sensor.

6. The sensor system according to claim 1, wherein the analyzer circuit includes a measuring shunt situated in a supply line to measure the measuring signal conducted over the supply line.

7. The sensor system according to claim 1, wherein the analyzer circuit includes a comparator.

8. The sensor system according to claim 1, wherein the sensor is a wheel rotational-speed sensor, which includes at least one switched current source, whose current signal is modulated onto a supply line.
